(19) United States
(12) Patent Application Publication
(10) Pub. No.: US 2026/0017232 A1
(43) Pub. Date: Jan. 15, 2026

(54) Load Balancing Methods

(71) Applicant: Tencent Technology (Shenzhen) Company Limited, Shenzhen (CN)

(72) Inventor: Kaikai Ge, Shenzhen (CN)

(21) Appl. No.: 19/335,310

(22) Filed: Sep. 22, 2025

Related U.S. Application Data
(63) Continuation of application No. PCT/CN2024/107229, filed on Jul. 24, 2024.

(30) Foreign Application Priority Data
Sep. 22, 2023 (CN) 2023112352265

(51) Int. Cl. G06F 16/11; G06F 9/50; G06F 16/185

(52) U.S. Cl. CPC G06F 16/119; G06F 9/505; G06F 16/185

(57) ABSTRACT

Load balancing methods and systems are described herein. A method may be performed by one metadata server in a distributed file system, and may include creating at least one second directory for a first directory in response to a directory creation operation triggered for the first directory. The following operations may be performed on each second directory: use, from other metadata servers, another metadata server whose current load value satisfies a preset load condition as a target metadata server, when it is determined, based on a directory category of the first directory and a hierarchy relationship between the first directory and the second directory, that the second directory satisfies a migration condition; and send directory information of the second directory to the target metadata server, to enable the target metadata server to create the second directory based on the received directory information of the second directory.

### CROSS REFERENCE TO RELATED APPLICATIONS

This application is a Continuation of PCT Application PCT/CN2024/107229, filed Jul. 24, 2024, entitled “LOAD BALANCING METHOD AND APPARATUS, ELECTRONIC DEVICE, MEDIUM, AND PROGRAM PRODUCT”, which claims priority to Chinese Patent Application No. 202311235226.5, filed Sep. 22, 2023, and entitled “LOAD BALANCING METHOD AND APPARATUS, AND ELECTRONIC DEVICE”, each of which is herein incorporated by reference in its entirety.

### FIELD

This application relates to the field of computer technologies, and in particular, to a load balancing method and apparatus, an electronic device, a medium, and a program product.

### BACKGROUND

A distributed file system (DFS) is a distributed storage system, provides three storage manners: object storage, block storage, and file storage, and has advantages such as high reliability, high scalability, and high performance. A distributed file system service provided by Ceph (CephFS) can store directories and files in an object-based storage device (OSD) of a Ceph cluster, and manage metadata of the file system by using a metadata server (MDS). CephFS is a type of DFS.

Directories in a file system may be accessed based on an operation triggered by an object. When a directory is frequently accessed or operated, the directory may be marked as a hotspot. Consequently, an MDS in which the directory is located may be under high load pressure, and performance of the entire file system is affected.

In the related art, to satisfy a file system access performance requirement, a plurality of MDSs are provided for load-balanced access. When it is detected that load of the MDS is excessively high, a directory corresponding to the MDS is migrated. Specifically, after it is detected that an access popularity of the directory reaches a threshold, the directory is usually migrated from the MDS with excessively high load to an MDS with low load by using a load balancing method.

Because consistency and integrity of data in the directory need to be ensured during migration, the directory needs to be frozen. In addition, if there is a subdirectory in the directory, the subdirectory also needs to be frozen, and the directory and the subdirectory are migrated together.

However, in the foregoing method, a data amount of the directory is large, and a migration process may cause high internal memory consumption. In addition, when the directory is frozen, operations on the directory are suspended, and consequently, a request for the directory can not continue to be executed until the directory is unfrozen. This may cause a request delay, increase feedback time, and reduce feedback efficiency. As a result, use experience of the object deteriorates.

### SUMMARY

An objective described herein is to provide a load balancing method and apparatus, and an electronic device, to provide a solution that can balance load allocation and improve performance of a file system.

According to a first aspect, this application provides a load balancing method, performed by one metadata server in a distributed file system, the method including:
creating at least one second directory for a first directory in response to a directory creation operation triggered for the first directory, the first directory being managed by the metadata server, and a hierarchy level of a second directory being less than a hierarchy level of the first directory; and
performing the following operations on each second directory:
selecting, from other metadata servers, another metadata server whose current load value satisfies a preset load condition as a target metadata server, when it is determined, based on a directory category of the first directory and a hierarchy relationship between the first directory and the second directory, that the second directory satisfies a migration condition; and
sending directory information of the second directory to the target metadata server, and locally deleting the directory information of the second directory, to enable the target metadata server to create the second directory based on the received directory information of the second directory, and storing the operation data into the second directory when operation data for the second directory is subsequently received.

According to a second aspect, this application provides a load balancing apparatus, including:
a creation module, configured to create at least one second directory for a first directory in response to a directory creation operation triggered for the first directory, the first directory being managed by one metadata server, and a hierarchy level of a second directory being less than a hierarchy level of the first directory;
the following operations being performed on each second directory:
a selection module, configured to select, from other metadata servers, another metadata server whose current load value satisfies a preset load condition as a target metadata server, when it is determined, based on a directory category of the first directory and a hierarchy relationship between the first directory and the second directory, that the second directory satisfies a migration condition; and
a sending module, configured to: send directory information of the second directory to the target metadata server, and locally delete the directory information of the second directory, to enable the target metadata server to create the second directory based on the received directory information of the second directory, and store the operation data into the second directory when operation data for the second directory is subsequently received.

According to a third aspect, an aspect described herein provides an electronic device, including a processor and a memory, the memory having program code stored herein, and when the program code is executed by the processor, the processor being enabled to perform any operation in the method in the first aspect.

According to a fourth aspect, an aspect described herein provides a computer storage medium, the computer storage medium storing computer instructions, and when the computer instructions are run on a computer, the computer being enabled to perform any operation in the method in the first aspect.

According to a fifth aspect, an aspect described herein provides a computer program product, including a computer program, the computer program being stored in a computer-readable storage medium, and when the processor of the electronic device reads the computer program from the computer-readable storage medium, the processor executing the computer program, to enable the electronic device to perform any operation of the method in the first aspect.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is a schematic diagram of a dynamic balancing method in a related technology according to an aspect described herein.

FIG. 2 is a schematic diagram of an application scenario according to an aspect described herein.

FIG. 3 is an implementation flowchart of a load balancing method according to an aspect described herein.

FIG. 4 is a schematic diagram of a structure of a first directory and a second directory according to an aspect described herein.

FIG. 5 is a flowchart of determining that a migration condition is satisfied according to an aspect described herein.

FIG. 6 is a schematic diagram of load information transmission according to an aspect described herein.

FIG. 7 is a schematic diagram of load value comparison according to an aspect described herein.

FIG. 8 is a schematic diagram of load balancing according to an aspect described herein.

FIG. 9 is an overall flowchart of load balancing according to an aspect described herein.

FIG. 10 is a schematic diagram of determining migration by a metadata server according to an aspect described herein.

FIG. 11 is a flowchart of determining migration by a metadata server according to an aspect described herein.

FIG. 12 is a schematic diagram of directory migration by a metadata server according to an aspect described herein.

FIG. 13 is a schematic diagram of a structure of a load balancing apparatus according to an aspect described herein.

FIG. 14 is a schematic diagram of a structure of an electronic device according to an aspect described herein.

FIG. 15 is a schematic diagram of a structure of an electronic device according to an aspect described herein.

### DETAILED DESCRIPTION

To make objectives, technical solutions, and advantages of aspects described herein clearer, the following describes the technical solutions with reference to the accompanying drawings. The described aspects are a part rather than all of aspects of the technical solutions described herein.

To facilitate better understanding of the technical solutions described herein by a person skilled in the art, some terms described herein are described below.
1. A distributed file system (DFS) is a distributed storage system, provides three storage manners: object storage, block storage, and file storage, and has advantages such as high reliability, high scalability, and high performance. A DFS service provided by Ceph (CephFS) can store directories and files in an object-based storage device (OSD) of a Ceph cluster, and manage metadata of the file system by using a metadata server (MDS).
2. A heartbeat mechanism is a mechanism for monitoring and maintaining active states of two communication parties, and is a very important server supervision tool. A running state and availability of a server can be monitored in real time by continuously sending a heartbeat packet, to detect and correct a fault in time and improve stability of a system.
3. A central processing unit (CPU) is one of main components in a computer system, and is also referred to as a microprocessor or a central processing unit chip.
4. A hashmap is a common data structure, and is implemented based on a hash table. The hash table is a data structure for efficient storage and retrieval by calculating a hash value of data. The hashmap stores data in a form of a key-value pair, where a key is unique and a value may be repeated. The hashmap maps a key to a hash value by using a hash function, and then stores a corresponding key-value pair in an internal array by using the hash value as an index.
5. An index node (inode) is a data structure for storing a file attribute and a data block position. Each file has a corresponding inode in the file system, the inode includes metadata information of the file, for example, a file type, a permission, an owner, creation time, and a size, and also includes a pointer pointing to an area in which actual data of the file is located.
6. A log event refers to a log record and event generated by the system or an application program during running. The log event is configured for recording information about the system, such as a behavior, an error condition, an alarm, and a state change, so that fault diagnosis, problem debugging, performance analysis, security auditing, and the like can be performed. The log event is a mechanism for recording a running state of a system, and is usually stored in a structured format.
7. A reliable automatic distributed object store (rados) is a distributed object storage system, and is one of core components of a Ceph storage system.
8. Migrator: In the field of computers, the migrator is usually configured to migrate data, an application program, a system configuration, and the like from one environment to another environment. For example, a database migrator is configured to migrate a database from one platform or version to another platform or version.

The words “exemplary” and “illustrative” used below mean “used as an example, an aspect, or descriptions”. Any aspect described as “illustrative” is not necessarily construed as being preferred than or better than another aspect.

The terms “first” and “second” herein are merely used for a purpose of description, and cannot be understood as explicitly indicating or implying relative importance or implicitly specifying a quantity of indicated technical features. Therefore, a feature limited by “first” and “second” may explicitly or implicitly include one or more such features. In the descriptions of aspects described herein, unless otherwise specified, “a plurality of” means two or more.

The following briefly describes a design idea of aspects described herein.

A distributed file system (DFS) is a distributed storage system, provides three storage manners: object storage, block storage, and file storage, and has advantages such as high reliability, high scalability, and high performance. A DFS service provided by Ceph (CephFS) can store directories and files in an object-based storage device (OSD) of a Ceph cluster, and manage metadata of the file system by using a metadata server (MDS). A load balancing method and apparatus, an electronic device, a medium, and a program product provided in aspects described herein may be applied to or used in the field of cloud technologies or the computing field.

Directories in a file system may be accessed based on an operation triggered by an object. When a directory is frequently accessed or operated, the directory may be marked as a hotspot. Consequently, an MDS in which the directory is located may be under high load pressure, and performance of the entire file system is affected.

In the related art, to satisfy a file system access performance requirement, a plurality of MDSs are provided for load-balanced access. When it is detected that load of the MDS is excessively high, a directory corresponding to the MDS is migrated. Specifically, after it is detected that an access popularity of the directory reaches a threshold, the directory is usually migrated from the MDS with excessively high load to an MDS with low load by using a load balancing method.

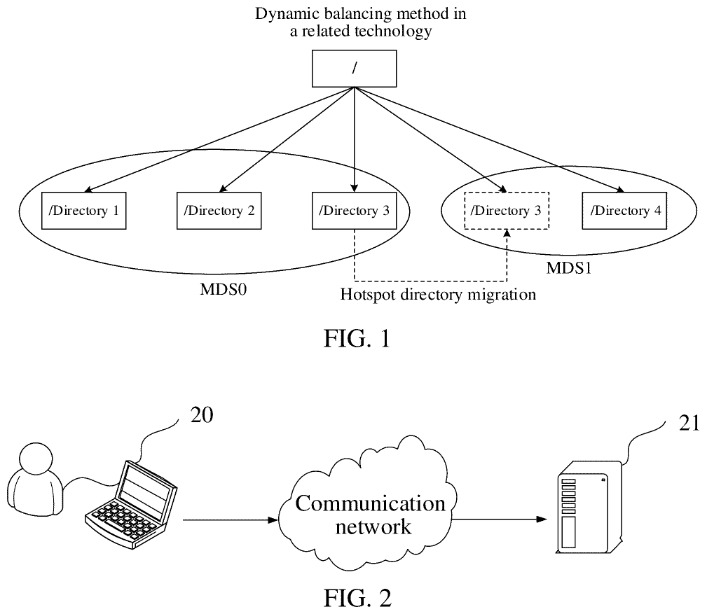

For example, as shown in FIG. 1, a used load balancing method may be a dynamic load balancing method. An MDS0 manages a directory 1, a directory 2, and a directory 3, and an MDS1 manages a directory 4. If it is detected that the directory 3 is frequently accessed, the directory 3 is migrated to the MDS1. A dashed-line arrow in FIG. 1 represents a migration process of the directory 3.

Because consistency and integrity of data in the directory need to be ensured during migration, the directory 3 needs to be frozen. In addition, if there is a subdirectory in the directory, the subdirectory also needs to be frozen, and the directory 3 and the subdirectory are migrated together.

However, in the foregoing method, a data amount of the directory is large, and a migration process may cause high internal memory consumption. In addition, when the directory is frozen, operations on the directory are suspended, and consequently, a request for the directory can continue to be executed until the directory is unfrozen. This may cause a request delay, increase feedback time, and reduce feedback efficiency. As a result, use experience of the object deteriorates.

Therefore, to resolve the foregoing problem, an aspect described herein provides a load balancing method. The method mainly includes: determining whether a corresponding second directory satisfies a migration condition, when at least one second directory is created for a local first directory, and migrating a second directory that satisfies the migration condition to a target metadata server that satisfies a preset load condition. Described herein, the second directory that satisfies the migration condition is migrated on an occasion of creating the second directory. There is no operation data in the second directory, so that load balancing performed at the occasion causes a small amount of data to be migrated in a load balancing process. This reduces load pressure during processing of the metadata server.

Further, in a related technology, when a directory is migrated, to ensure consistency and integrity of data during directory migration, the migrated directory needs to be frozen. An operation request for the migrated directory cannot be performed in a period in which the migrated directory is frozen, resulting in a request delay, and affecting performance of a metadata server. However, described herein, when the second directory is created, there is no operation request for the second directory, and therefore, the second directory does not need to be frozen, so that a problem of the request delay caused by freezing the directory is avoided.

In addition, in this aspect described herein, before the second directory is migrated, for each second directory that satisfies the migration condition, one metadata server whose current load value satisfies the preset load condition is selected from a plurality of metadata servers as the target metadata server, and each second directory that satisfies the migration condition can be respectively migrated, based on a load status of a current metadata server, to a corresponding target metadata server that satisfies the preset load condition.

In other words, as described herein, a plurality of directories corresponding to one object may be dispersed on different metadata servers based on load statuses of the plurality of metadata servers, to balance load of the plurality of metadata servers.

Therefore, in a process of migrating the at least one second directory as described herein, for each second directory, the second directory is migrated to the target metadata server whose current load value satisfies the load condition, so that the load of the plurality of metadata servers is more balanced, to improve a load balancing capability of each metadata server, reduce a possibility that excessively high load suddenly exists on a metadata server subsequently, and improve performance of the metadata server.

FIG. 2 is a schematic diagram of an application scenario according to an aspect described herein. The schematic diagram of the application scenario includes a terminal device 20 and a server 21. The terminal device 20 may communicate with the server 21 by using a communication network.

In an implementation, the communication network may be a wired network or a wireless network. Therefore, the terminal device 20 and the server 21 may be directly or indirectly connected in a wired or wireless communication manner. This is not specifically limited in this aspect described herein.

In this aspect described herein, the terminal device 20 is an electronic device used by an object. The electronic device may be a mobile phone, a computer, an intelligent voice interaction device, a smart household, a vehicle-mounted terminal, an aircraft, or the like.

The server 21 may be an independent physical server, or may be a server cluster or a distributed system including a plurality of physical servers. Alternatively, the server 21 may be a cloud server providing basic cloud computing services such as a cloud service, a cloud database, cloud computing, cloud storage, a cloud function, a network service, cloud communication, a middleware service, a domain name service, a security service, a content delivery network (CDN), big data, and an artificial intelligence platform.

The load balancing method in this aspect described herein may be performed by the terminal device 20 and the server 21 through interaction.

The following describes the load balancing method provided in the illustrative implementations described herein with reference to the foregoing described application scenario and with reference to the accompanying drawings. The foregoing application scenario is merely shown for ease of understanding the spirit and principle described herein, and implementations described herein are not limited in this aspect.

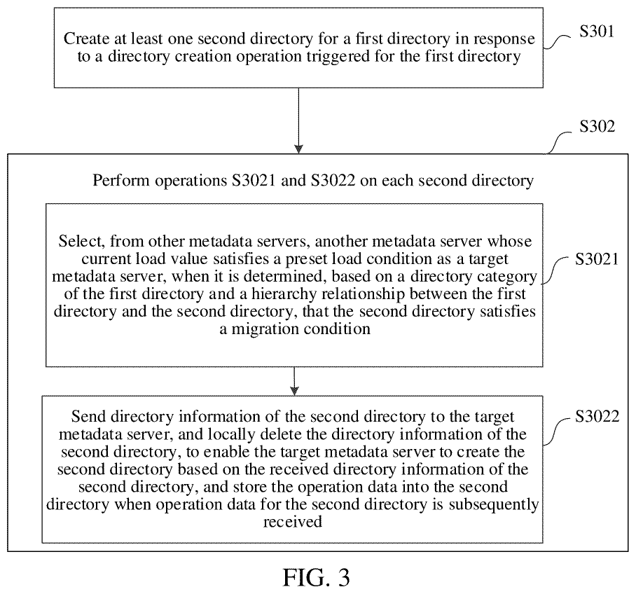

FIG. 3 is an implementation flowchart of a load balancing method according to an aspect described herein. The method is applied to a metadata server in a distributed file system. A specific implementation procedure of the method is as follows:

Operation S301: Create at least one second directory for a first directory in response to a directory creation operation triggered for the first directory.

A hierarchy level of the second directory is less than a hierarchy level of the first directory.

The load balancing method in this aspect described herein can be applied to any metadata server in the distributed file system. Different metadata servers manage different directories. Therefore, if the directory creation operation is triggered for the first directory, the load balancing method is performed by a metadata server managing the first directory.

In this aspect described herein, the directory creation operation for the first directory may be triggered by an object, or the target creation operation for the first directory may be automatically triggered based on a program. This is not limited as described herein.

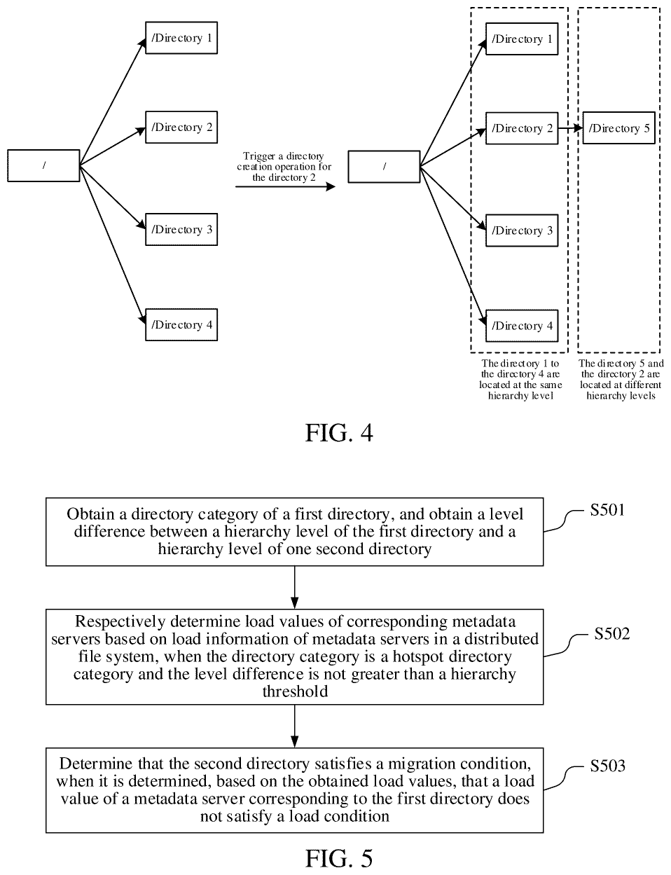

FIG. 4 is a schematic diagram of a structure of a first directory and a second directory according to an aspect described herein. If a directory creation operation is triggered for a directory 2 shown in the left portion of FIG. 4, a directory structure shown in the right portion of FIG. 4 is obtained.

A directory 5 is a subdirectory created for the directory 2, a directory 1 to a directory 4 are directories at the same hierarchy level, and a hierarchy level of the directory 5 is lower than the hierarchy level of the directory 1 to the directory 4. If a directory 6 is created for the directory 5, a hierarchy level of the directory 6 is lower than the hierarchy level of the directory 5. If a directory 7 is created for the directory 2, a hierarchy level of the directory 7 is equal to the hierarchy level of the directory 5 and is higher than the hierarchy level of the directory 6.
Operation S302: Perform operations S3021 and S3022 on each second directory.

Operation S3021: Select, from other metadata servers, another metadata server whose current load value satisfies a preset load condition as a target metadata server, when it is determined, based on a directory category of the first directory and a hierarchy relationship between the first directory and one second directory, that the second directory satisfies a migration condition.

In this aspect, the hierarchy relationship between the first directory and the second directory may be a level difference between the hierarchy level of the first directory and the hierarchy level of the second directory.

In this aspect, when it is determined that the directory category of the first directory is a hotspot directory category and the level difference is not greater than a hierarchy threshold, a load value of the metadata server managing the first directory is determined. After it is determined that the load value of the metadata server does not satisfy the load condition, it is determined that the second directory satisfies the migration condition.

FIG. 5 is a flowchart of determining that a migration condition is satisfied according to an aspect described herein. Specific operations are as follows:

Operation S501: Obtain the directory category of the first directory, and obtain the level difference between the hierarchy level of the first directory and the hierarchy level of the second directory.

In this aspect, it is determined, in at least one of the following manners, that the directory category of the first directory is the hotspot directory category:

Manner 1: It is determined, when a service corresponding to the first directory is a hotspot service, that the directory category of the first directory is the hotspot directory category.

In this aspect, based on a mapping relationship between a directory and a service, when it is determined that the service is the hotspot service, a directory category of the directory corresponding to the service is the hotspot directory category.

There are a plurality of types of services in the distributed file system. When service planning is performed for the distributed file system, whether directories corresponding to different services may be frequently accessed is determined based on the types of the services. If a directory is frequently accessed, a service corresponding to the directory is the hotspot service.

The service planning is planning the mapping relationship between a directory and a service, and planning specific services that are hotspot services.

Manner 2: It is determined, when an access popularity of the first directory is greater than a popularity threshold, that the category of the first directory is the hotspot directory category.

The access popularity of the first directory is stored in metadata of the first directory, and the metadata server managing the first directory can obtain the access popularity of the first directory.

In this aspect, whether the category of the first directory is the hotspot directory category is periodically determined based on the access popularity of the first directory.

In an implementation, the access popularity of the first directory may be determined, based on a preset screening condition, from a plurality of access popularities corresponding to a periodicity.

For example, the preset screening condition may be any one of the following: a maximum access popularity value, an average value of the maximum access popularity value and a minimum access popularity value, and the like. This application is not limited thereto.

In another implementation, the access popularity of the first directory may be an average access popularity corresponding to the periodicity.

For example, the periodicity may be set to five minutes.

Operation S502: Respectively determine load values of corresponding metadata servers based on load information of metadata servers in the distributed file system, when the directory category is the hotspot directory category and the level difference is not greater than the hierarchy threshold.

When the directory category is the hotspot directory category and the level difference is not greater than the hierarchy threshold, whether the second directory needs to be migrated is determined based on the load values of the metadata servers.

The metadata servers include one metadata server corresponding to the first directory.

In this aspect, load information that is of other metadata servers and that is obtained by the metadata server is transmitted by the other metadata servers to the metadata server by using a heartbeat mechanism.

In an implementation, a metadata server may transmit load information based on a preset sending frequency.

For example, the preset sending frequency may be 10 s.

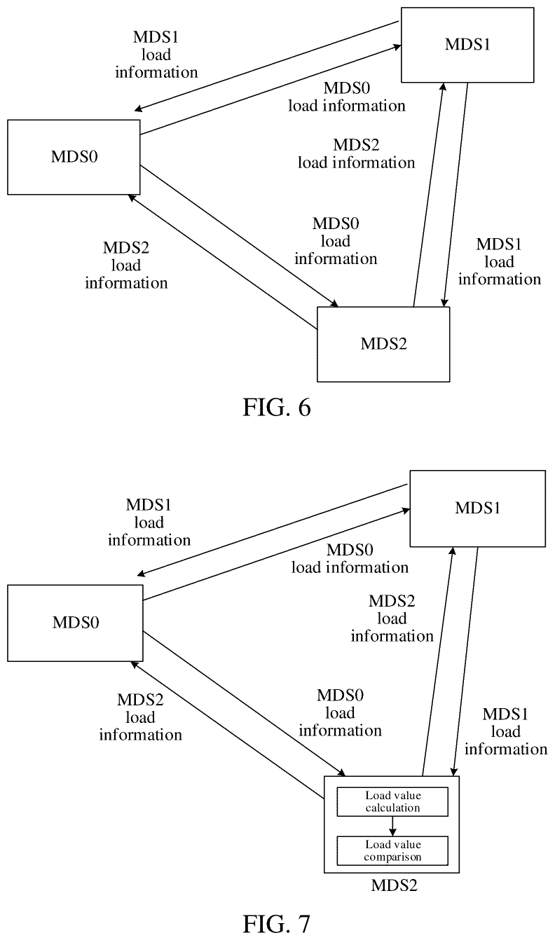

FIG. 6 is a schematic diagram of load information transmission according to an aspect described herein. An example in which the distributed file system includes three MDSs is used. An MDS0 separately transmits load information to an MDS1 and an MDS2 by using the heartbeat mechanism (indicated by “heartbeat” in FIG. 6). The MDS1 separately transmits load information to the MDS0 and the MDS2 by using the heartbeat mechanism. The MDS2 separately transmits load information to the MDS0 and the MDS1 by using the heartbeat mechanism.

The heartbeat mechanism is a mechanism for monitoring an active state and maintaining a connection by periodically sending signals, to improve reliability and stability of a system.

For example, in this aspect, the load information includes at least a load degree, a request processing speed, and a quantity of to-be-processed requests of the metadata server.

In this aspect, when the load values of the corresponding metadata servers are determined based on the load information of the metadata servers, the following operation is performed on each metadata server: performing weighted summation on the load degree, the request processing speed, and the quantity of the to-be-processed requests of the metadata server, to obtain a load value corresponding to the metadata server.

The load degree represents a quantity of requests currently processed by the metadata server, and the load value represents a pressure degree of the metadata server.

For example, the load value is determined by using formula 1:

$$Y = 0.8 * a + 0.2 ( b + 10 * c ) \qquad Formula 1$$

Y represents the load value, a represents the load degree of the metadata server, b represents the request processing speed, and c represents the quantity of the to-be-processed requests.

The load degree of the metadata server may be determined by CPU load. A busy degree of the entire MDS may be learnt from the CPU load. A larger value corresponding to the load degree indicates a busier MDS. The request processing speed represents a speed at which the MDS processes a client request, and a higher speed indicates a busier MDS. The quantity of to-be-processed requests is a quantity of queued requests, reflecting a change of a quantity of requests to be processed by the MDS, and more requests to be processed indicate a higher change rate, and indicate a busier MDS.

Therefore, a larger obtained load value indicates a larger pressure degree of the metadata server.

Described herein, the pressure degree of the MDS is reflected based on multi-dimensional load information, so that accuracy of analyzing the metadata server can be improved in a load balancing process.

In this aspect, the load information of the other metadata servers and the load information of the metadata server may be maintained together in one hashmap. In this way, when the load values of the metadata servers are determined subsequently, the load information of the corresponding metadata server is obtained.

The hashmap is a set of key-value pairs. Each metadata server maintains a hashmap set.

Operation S503: Determine that the second directory satisfies the migration condition, when it is determined, based on the obtained load values, that the load value of the metadata server corresponding to the first directory does not satisfy the load condition.

In this aspect, the obtained load values are sorted in ascending order, to determine ranking sequence numbers corresponding to the load values. With reference to a preset sequence number, if a ranking sequence number of the load value of the metadata server corresponding to the first directory is greater than the preset sequence number, that is, the load value of the metadata server corresponding to the first directory is large, it is determined that the load value of the metadata server corresponding to the first directory does not satisfy the load condition.

For example, if the preset sequence number is 1, and the ranking sequence number corresponding to the load value of the metadata server corresponding to the first directory is greater than 1, that is, the load value of the metadata server corresponding to the first directory is not a minimum value, it is determined that the load value of the metadata server corresponding to the first directory does not satisfy the load condition. If the preset sequence number is 3, and the ranking sequence number corresponding to the load value of the metadata server corresponding to the first directory is greater than 3, it is determined that the load value of the metadata server corresponding to the first directory does not satisfy the load condition.

Therefore, the second directory needs to be migrated to another metadata server. In other words, it is determined that the second directory satisfies the migration condition.

FIG. 7 is a schematic diagram of load value comparison according to an aspect described herein. Based on FIG. 6, if the metadata server corresponding to the first directory is the MDS2 in FIG. 6, after obtaining the load information transmitted by the MDS0 and the MDS1, the MDS2 determines load values corresponding to the MDS0, the MDS1, and the MDS2, and performs load value comparison based on the determined load values.

After it is determined, based on the foregoing process, that the second directory satisfies the migration condition, a target metadata server is determined based on operation A1 and operation A2.

Operation A1: Sort load values corresponding to other metadata servers in ascending order, to obtain at least one candidate load value based on ranking sequence numbers corresponding to the load values and with reference to the preset sequence number.

A ranking sequence number of the at least one candidate load value is less than the preset sequence number.

An example in which the distributed file system includes the MDS0, the MDS1, and the MDS2 is used. If the metadata server corresponding to the first directory is the MDS0, after it is determined that the second directory satisfies the migration condition, the MDS1 and the MDS2 are the other metadata servers in operation A1, and the load values corresponding to the MDS1 and the MDS2 are sorted, to obtain at least one candidate load value.

In an implementation, because the ranking sequence number of the candidate load value is less than the preset sequence number, it is determined that the candidate load value satisfies the preset load condition.

Operation A2: Select, as the target metadata server, another metadata server from at least one other metadata server corresponding to the at least one candidate load value.

In this aspect, when the target metadata server is determined based on the at least one candidate load value, another metadata server may be selected as the target metadata server in either of the following manners:

Manner 1: Another metadata server corresponding to one candidate load value that is in the at least one candidate load value and that satisfies a screening condition is used as the target metadata server.

The screening condition in this aspect may be either of the following: A load value is the minimum, and a ranking sequence number of the load value is 2.

Manner 2: Another metadata server corresponding to one candidate load value randomly selected from the at least one candidate load value is used as the target metadata server.

Based on the foregoing process, in this aspect, the target metadata server to which the second directory needs to be migrated is determined.

Operation S3022: Send directory information of one second directory to the target metadata server, and locally delete the directory information of the second directory, to enable the target metadata server to create the second directory based on the received directory information of the second directory, and store the operation data into the second directory when operation data for the second directory is subsequently received.

For example, the directory information includes at least a directory size, directory creation time, modification time, a creator of the directory, a permission of the directory, and an extended attribute.

The directory information may be stored as an inode, one directory corresponds to one inode, and one inode includes directory information corresponding to the directory.

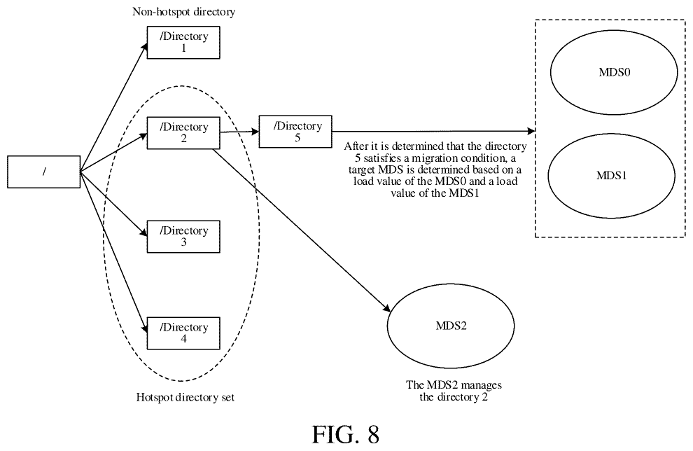

FIG. 8 is a schematic diagram of load balancing according to an aspect described herein. If directory categories of a directory 2, a directory 3, and a directory 4 are hotspot directories, a directory 5 is created for the directory 2. If a level difference between the directory 2 and the directory 5 is greater than a preset hierarchy threshold, a target metadata server may be determined based on load values of an MDS0, an MDS1, and an MDS2. Then, a created subdirectory is in the MDS0, the MDS1, and the MDS2, and one metadata server satisfying a preset load condition is used as the target metadata server.

In this aspect, after creating the second directory, the target metadata server may bind the second directory to a corresponding target metadata server. In this way, during subsequent load balancing, the second directory is no longer migrated to another metadata server. A process of adjusting the directory due to an instant change of load is avoided, an amount of data that needs to be processed is reduced, redundant operations are reduced, and resource consumption is reduced.

A dynamic load balancing method used in a related technology is intended to dynamically adjust, based on a real-time load status and overall performance of a system, routing and data distribution of a client request, to implement better load balancing and performance optimization. Therefore, in the dynamic load balancing method used in the related technology, a directory is not bound to a metadata server, then the directory may be migrated to another metadata server due to an instant increase in load, and is adjusted back to the original metadata server after the load is reduced. As a result, many unnecessary adjustment processes are caused, an amount of processed data is increased, resource consumption is increased, and performance of the file system is affected.

In addition, in the related technology, the directory is usually bound to the metadata server by using a static load balancing method. However, in the static load balancing method, load allocation of a current cluster during service feedback does not satisfy a performance requirement. For example, it is detected that a delay of a request significantly increases. Then a directory is manually bound to another metadata server based on a status of cluster detection feedback. As a result, the static load balancing method has some hysteresis.

Therefore, balanced migration is performed on load by using the load balancing method in this aspect described herein, and the migrated load is bound to a metadata server to which the load is migrated, so that a problem of repeated migration adjustment of a directory that exists in the dynamic load balancing method in the related technology can be avoided, and a problem of hysteresis of load balancing migration existing in the static load balancing method can be avoided.

Based on FIG. 8, because the directory category of the directory 1 is not the hotspot directory, after the subdirectory of the directory 1 is created, load balancing does not need to be performed on the subdirectory of the directory 1.

For example, if the directory 1 is bound to the MDS0, after the subdirectory is created for the directory, the created subdirectory is also bound to the MDS0.

If the directory category of a first target is the hotspot directory, but the level difference is greater than the hierarchy threshold, the second directory is not migrated.

In this aspect described herein, the preset hierarchy threshold may be 10.

If a difference between the hierarchy level of the second directory and the hierarchy level of the first directory is greater than the hierarchy threshold, the amount of data that needs to be stored in the second directory is small, high load is not caused to the metadata server, and the second directory does not need to be migrated.

For example, if a plurality of subdirectories are created for the directory 2, and the directory 2 is a hotspot directory, load migration is not performed on a subdirectory whose level difference is greater than the hierarchy threshold in the plurality of created subdirectories. If the directory 2 is bound to the MDS2, a subdirectory on which load migration is not performed is directly bound to the MDS2.

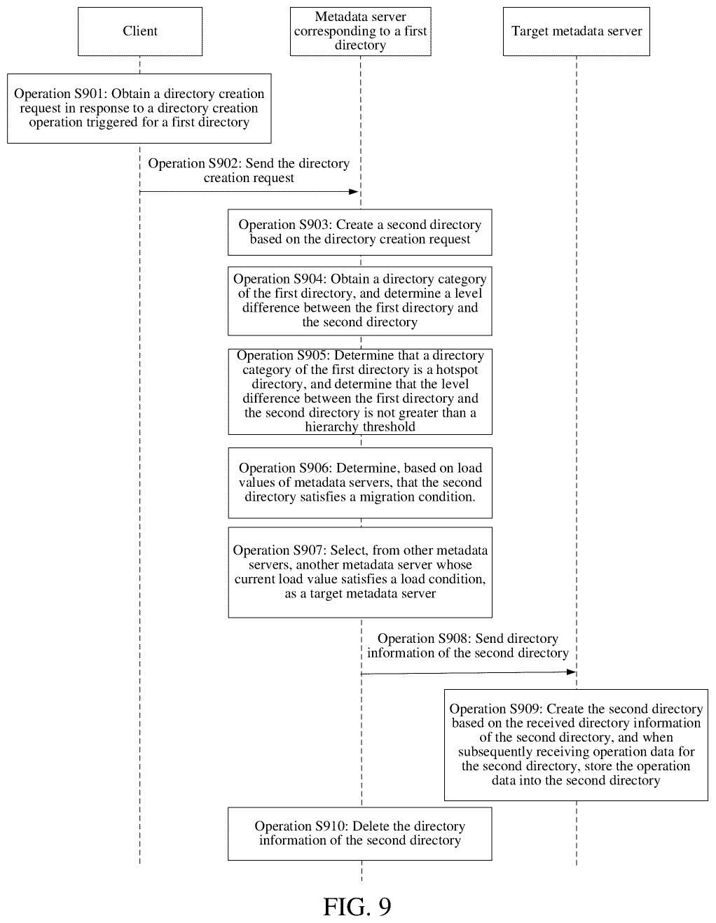

Because the second directory is created for the first directory, the second directory is not located at the same hierarchy level as the first directory. Therefore, a level difference between the second directory and the first directory is at least 1. A specified range of the hierarchy threshold is not limited as described herein. In addition, because a depth of directory creation is usually not excessively large, after an appropriate hierarchy threshold is set as described herein, level differences corresponding to most newly created directories may be made not greater than the hierarchy threshold. FIG. 9 is an overall flowchart of load balancing according to an aspect described herein. An example in which one second directory is created is used. Specific operations are as follows:

Operation S901: Obtain a directory creation request in response to a directory creation operation triggered for a first directory.

Operation S902: A client sends the directory creation request to a metadata server corresponding to the first directory.

Operation S903: The metadata server corresponding to the first directory creates a second directory based on the directory creation request.

When the second directory is created, a path name of the second directory is obtained. The path name includes a parent directory of the second directory. That is, a connection relationship between the directory and the parent directory can be embodied in the path name of the directory. The parent directory of the second directory is the first directory.

Operation S904: The metadata server corresponding to the first directory obtains a directory category of the first directory, and determines a level difference between the first directory and the second directory.

Operation S905: Determine that a directory category of the first directory is a hotspot directory, and determine that the level difference between the first directory and the second directory is not greater than a hierarchy threshold.

Operation S906: The metadata server corresponding to the first directory determines, based on load values of metadata servers, that the second directory satisfies a migration condition.

Operation S907: The metadata server corresponding to the first directory selects, from other metadata servers, another metadata server whose current load value satisfies a load condition as a target metadata server.

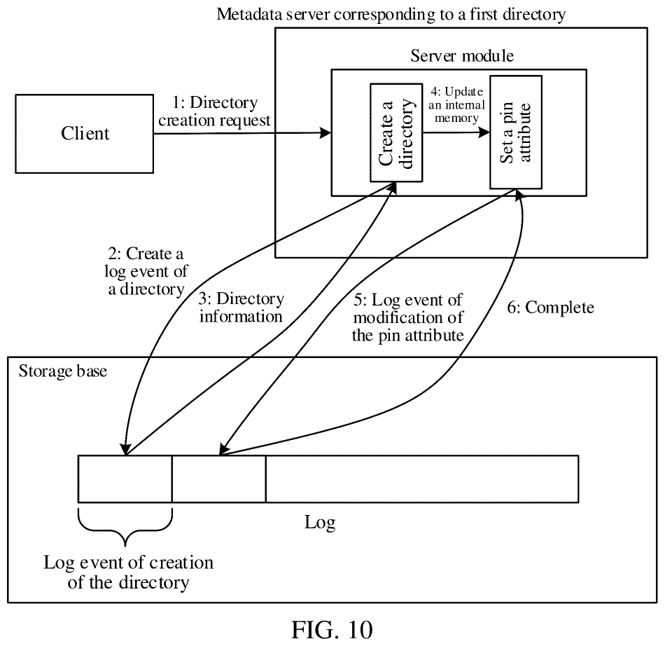

Based on the foregoing operations S901 to S907, FIG. 10 is a schematic diagram of determining migration by a metadata server according to an aspect described herein. The client sends, in response to the directory creation operation, the directory creation request to a corresponding metadata server. After the metadata server receives the directory creation request, a server module in the metadata server creates the directory. The server module generates a log event when performing the directory creation operation, writes the log event into a storage base (rados) of Ceph, and determines directory information corresponding to a newly created directory. After writing of the log event is completed, the determined directory information is sent back to the server module. The server module updates, based on the received directory information, data corresponding to the newly created directory in an internal memory, and determines whether the newly created directory satisfies the migration condition. If the newly created directory satisfies the migration condition, the server module modifies a pin attribute of the newly created directory into the target metadata server.

To ensure transactional performance of an operation, when the pin attribute of the newly created directory is modified, a corresponding log event also needs to be generated and written into the storage base (rados).

The directory information may be an inode.

In this aspect, when modifying the pin attribute of the newly created directory, the metadata server modifies the pin attribute in a vxattr attribute.

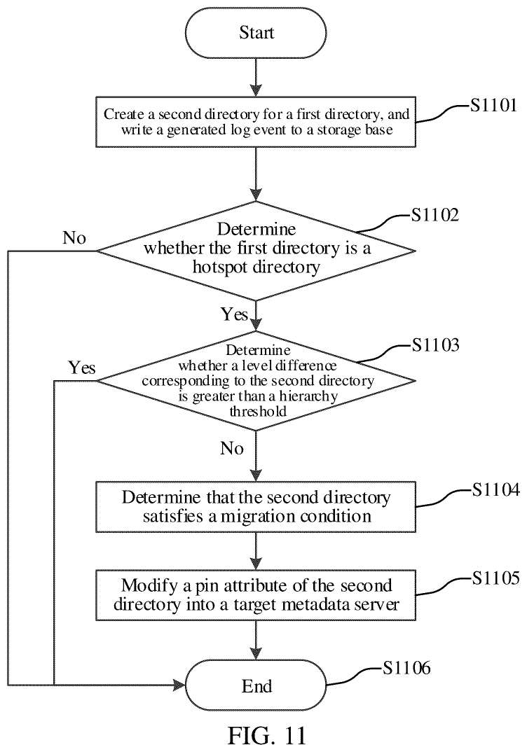

FIG. 11 is a flowchart of determining migration by a metadata server according to an aspect described herein. Specific operations are as follows:

Operation S1101: Create the second directory for the first directory, and write the generated log event to the storage base.

Operation S1102: Determine whether the first directory is the hotspot directory. If the first directory is the hotspot directory, perform operation S1103. If the first directory is not the hotspot directory, perform operation S1106.

Operation S1103: Determine whether the level difference corresponding to the second directory is greater than the hierarchy threshold. If the second directory is greater than the hierarchy threshold, perform operation S1106. If the second directory is not greater than the hierarchy threshold, perform operation S1104.

Operation S1104: Determine that the second directory satisfies the migration condition.

In an implementation, after it is determined, based on the load values of the metadata servers, that a load value of the metadata server corresponding to the first directory does not satisfy the load condition, it is determined that the second directory satisfies the migration condition.

Operation S1105: Modify a pin attribute of the second directory into the target metadata server, generate the log event and write the log event into the storage base.

Operation S1106: End.

Based on the foregoing process, it is determined that the newly created second directory needs to be migrated to the target metadata server.

The second directory is migrated through the following process.
Operation S908: The metadata server corresponding to the first directory sends the directory information of the second directory to the target metadata server.

Operation S909: The target metadata server creates the second directory based on the received directory information of the second directory, and when subsequently receiving operation data for the second directory, the target metadata server stores the operation data into the second directory.

Operation S910: The metadata server corresponding to the first directory deletes the directory information of the second directory.

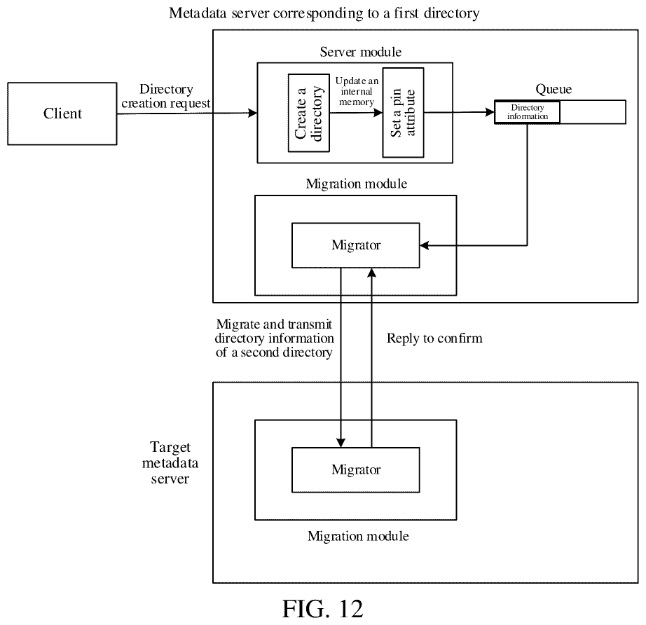

Based on the foregoing operations S908 to S910, FIG. 12 is a schematic diagram of directory migration by a metadata server according to an aspect described herein. Based on the procedure shown in FIG. 11, after the metadata server corresponding to the first directory modifies the pin attribute of the second directory, the directory information corresponding to the second directory is added to a queue, to perform asynchronous binding and migration. During asynchronous binding and migration, a migration module of the metadata server corresponding to the first directory takes out the directory information of the second directory from the queue, sends the directory information to a migration module corresponding to a target metadata server, and deletes locally stored directory information of the second directory.

The migration module of the metadata server corresponding to the first directory sends, by using a migrator, the directory information of the second directory to a migrator in the migration module of the target metadata server.

In this aspect, the migration module may be an MDBalancer module.

Based on the foregoing process, in this aspect described herein, balanced migration of the second directory is completed.

For ease of description, the foregoing parts are divided into modules based on functions and are separately described. Certainly, in an implementation described herein, functions of the modules may be implemented in one or more pieces of software or hardware.

A person skilled in the art can understand that various aspects described herein may be implemented as a system, a method, or a program product. Therefore, each aspect described herein may be specifically implemented in the following forms: a complete hardware implementation, a complete software implementation (including firmware, microcode, and the like), or an implementation combining hardware and software aspects, which may be collectively referred to as a “circuit”, a “module”, or a “system” herein.

For the apparatus in the foregoing aspect, specific execution manners of the modules have been described in detail in the aspects related to the method, and are not described in detail herein.

Based on the same inventive concept, an aspect described herein provides a load balancing apparatus. A principle of resolving a problem by the apparatus is similar to that of the method in the foregoing aspect. Therefore, for an implementation of the apparatus, refer to the implementation of the foregoing method. Repeated parts are not described in detail herein again.

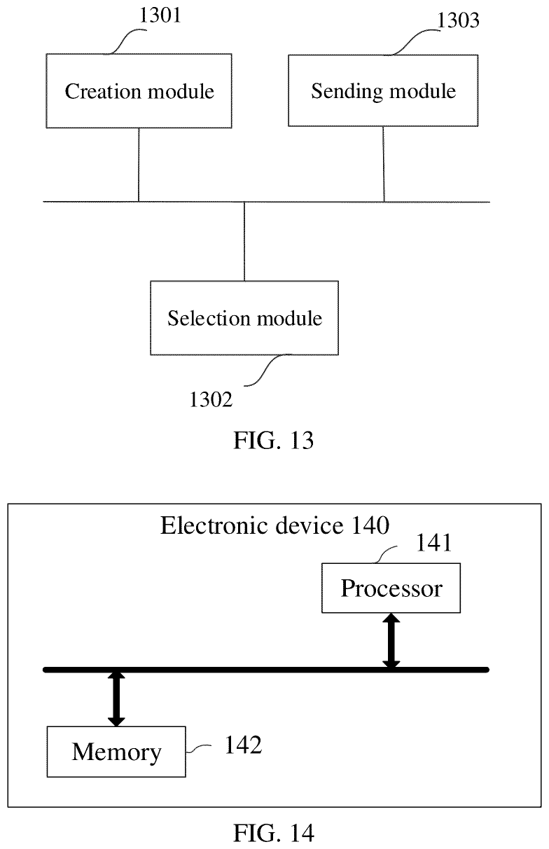

As shown in FIG. 13, an aspect described herein provides a load balancing apparatus 1300, including a creation module 1301, a selection module 1302, and a sending module 1303.

The creation module 1301 is configured to create at least one second directory for a first directory in response to a directory creation operation triggered for the first directory, the first directory being managed by one metadata server, and a hierarchy level of a second directory being less than a hierarchy level of the first directory.

The following operations are performed on each second directory:

The selection module 1302 is configured to select, from other metadata servers, another metadata server whose current load value satisfies a preset load condition as a target metadata server, when it is determined, based on a directory category of the first directory and a hierarchy relationship between the first directory and the second directory, that the second directory satisfies a migration condition.

The sending module 1303 is configured to: send directory information of the second directory to the target metadata server, and locally delete the directory information of the second directory, to enable the target metadata server to create the second directory based on the received directory information of the second directory, and store the operation data into the second directory when operation data for the second directory is subsequently received.

In an aspect, the selection module 1302 is further configured to:
obtain the directory category of the first directory, and obtain a level difference between the hierarchy level of the first directory and the hierarchy level of the second directory;
respectively determine load values of corresponding metadata servers based on load information of metadata servers in a distributed file system, when the directory category is a hotspot directory category and the level difference is not greater than a hierarchy threshold, the metadata servers including the metadata server; and
determine that the second directory satisfies the migration condition, when it is determined, based on the obtained load values, that the load value of the metadata server does not satisfy a load condition.

In an aspect, the selection module 1302 is further configured to determine, in at least one of the following manners, that the directory category of the first directory is the hotspot directory category:
determining, when a service corresponding to the first directory is a hotspot service, that the directory category of the first directory is the hotspot directory category; or
determining, when an access popularity of the first directory is greater than a popularity threshold, that the category of the first directory is the hotspot directory category.

In an aspect, the load information includes at least a load degree, a request processing speed, and a quantity of to-be-processed requests of the metadata server. The selection module 1302 is specifically configured to:
perform the following operation on load information of each metadata server:
performing weighted summation on the load degree, the request processing speed, and the quantity of the to-be-processed requests of the metadata server, to obtain a load value corresponding to the metadata server, the load degree representing a quantity of requests currently processed by the metadata server, and the load value representing a pressure degree of the metadata server.

In an aspect, the selection module 1302 is further configured to:
sort load values corresponding to other metadata servers in ascending order, to obtain at least one candidate load value based on ranking sequence numbers corresponding to the load values and with reference to a preset sequence number, a ranking sequence number of the at least one candidate load value being less than the preset sequence number; and
select, as the target metadata server, another metadata server from at least one other corresponding metadata server based on the at least one candidate load value.

In an aspect, the selection module 1302 is further configured to select another metadata server as the target metadata server in either of the following manners:
using, as the target metadata server, another metadata server corresponding to one candidate load value that is in the at least one candidate load value and that satisfies a screening condition; and
using, as the target metadata server, another metadata server corresponding to one candidate load value randomly selected from the at least one candidate load value.

In an aspect, load information that is of the other metadata servers and that is obtained by the metadata server is transmitted by the other metadata servers to the metadata server by using a heartbeat mechanism.

Based on the same inventive concept as the foregoing method aspect, an aspect described herein further provides an electronic device. A principle of the electronic device for resolving a problem is similar to that of the foregoing method aspect. Therefore, for an implementation of the electronic device, refer to the implementation of the foregoing method. Repeated parts are not described in detail herein again.

As shown in FIG. 14, the electronic device 140 may include at least a processor 141 and a memory 142. The memory 142 stores program code, and when the program code is executed by the processor 141, the processor 141 is enabled to perform the operations in the load balancing method according to any one of the foregoing aspects described herein.

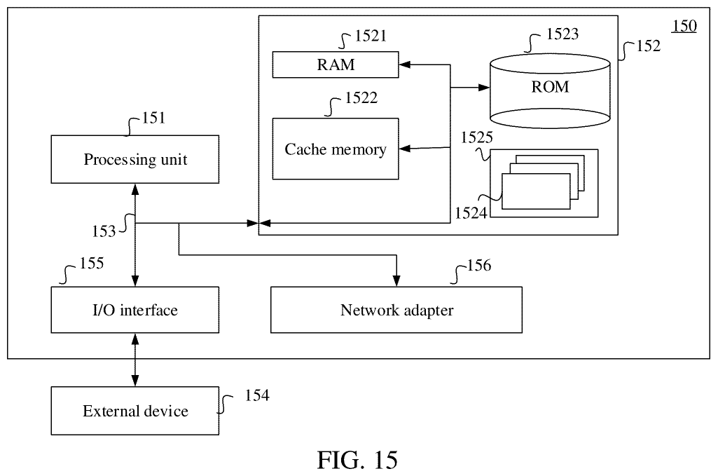

The following describes, with reference to FIG. 15, an electronic device 150 according to this implementation described herein. The electronic device 150 in FIG. 15 is merely an example, and is not to be construed as any limitation on a function and a use scope of aspects described herein.

As shown in FIG. 15, the electronic device 150 is represented in a form of a general-purpose electronic device. Components of the electronic device 150 may include, but are not limited to, at least one processing unit 151, at least one storage unit 152, and a bus 153 connecting different system components (including the storage unit 152 and the processing unit 151).

The bus 153 represents one or more of several types of bus structures, including a memory bus or a memory controller, a peripheral bus, a processor, or a local bus using any one of a plurality of bus structures.

The storage unit 152 may include a readable medium in a form of a volatile memory, for example, a random access memory (RAM) 1521 and/or a cache memory 1522, and may further include a readable medium in a form of a non-volatile memory, for example, a read-only memory (ROM) 1523.

The storage unit 152 may further include a program/utility 1525 that includes a group of program modules (at least one program module) 1524. The program module 1524 includes, but is not limited to: an operating system, one or more application programs, and another program module and program data. Each or a specific combination of these examples may include implementation of a network environment.

The electronic device 150 may also communicate with one or more external devices 154 (for example, a keyboard and a pointing device), may communicate with one or more devices that enable an object to interact with the electronic device 150, and/or communicate with any device (for example, a router and a modem) that enables the electronic device 150 to communicate with one or more other electronic devices. This type of communication may be performed through an input/output (I/O) interface 155. In addition, the electronic device 150 may further communicate with one or more networks (for example, a local area network (LAN), a wide area network (WAN), and/or a public network like the Internet) through a network adapter 156. As shown in the figure, the network adapter 156 communicates with another module of the electronic device 150 through the bus 153. Although not shown in the figure, another hardware and/or software module may be used in combination with the electronic device 150, including but not limited to: microcode, a device driver, a redundant processor, an external disk drive array, a redundant array of independent disks (RAID) system, a tape drive, a data backup storage system, and the like.

Based on the same inventive concept as the foregoing method aspect, various aspects of the load balancing method provided described herein may alternatively be implemented in a form of a program product, including program code. When the program product runs on an electronic device, the program code is used for enabling the electronic device to perform the operations in the load balancing method described in this specification and based on various illustrative implementations described herein.

The program product may use any combination of one or more readable media. The readable medium may be a readable signal medium or a readable storage medium. For example, the readable storage medium may be but is not limited to an electronic, magnetic, optical, electromagnetic, infrared, or semiconductor system, apparatus, or device, or any combination thereof. More specific examples (in a non-exhaustive list) of the readable storage medium include: an electrical connection having one or more wires, a portable disk, a hard disk drive, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The foregoing technical solutions are used in aspects described herein, and achieve at least the following technical effects:

In aspects described herein, whether a corresponding second directory satisfies a migration condition is determined when at least one second directory is created for a local first directory, and a second directory that satisfies the migration condition is migrated to a target metadata server that satisfies a preset load condition. Described herein, the second directory that satisfies the migration condition is migrated on an occasion of creating the second directory. There is no operation data in the second directory, so that load balancing performed at the occasion causes a small amount of data to be migrated in a load balancing process. This reduces load pressure during processing of the metadata server.

Further, in a related technology, when a directory is migrated, to ensure consistency and integrity of data during directory migration, the migrated directory needs to be frozen. An operation request for the migrated directory cannot be performed in a period in which the migrated directory is frozen, resulting in a request delay, and affecting performance of a metadata server. However, described herein, when the second directory is created, there is no operation request for the second directory, and therefore, the second directory does not need to be frozen, so that a problem of the request delay caused by freezing the directory is avoided.

In addition, in aspects described herein, before the second directory is migrated, for each second directory that satisfies the migration condition, one metadata server whose current load value satisfies the preset load condition is selected from a plurality of metadata servers as the target metadata server, and each second directory that satisfies the migration condition can be respectively migrated, based on a load status of a current metadata server, to a corresponding target metadata server that satisfies the preset load condition.

In other words, described herein, a plurality of directories corresponding to one object may be dispersed on different metadata servers based on load statuses of the plurality of metadata servers, to balance load of the plurality of metadata servers.

Therefore, in a process of migrating the at least one second directory described herein, for each second directory, the second directory is migrated to the target metadata server whose current load value satisfies the load condition, so that the load of the plurality of metadata servers is more balanced, to improve a load balancing capability of each metadata server, reduce a possibility that excessively high load suddenly exists on a metadata server subsequently, and improve performance of the metadata server.

Although preferred aspects described herein have been described, persons skilled in the art can make changes and modifications to these aspects once they learn the basic inventive concept. Therefore, the appended claims are intended to be construed as covering the preferred aspects and all changes and modifications falling within the scope described herein.

Clearly, persons skilled in the art can make various modifications and variations to this application without departing from the spirit and scope described herein. In this case, this application is intended to cover these modifications and variations of aspects described herein provided that they fall within the scope of the claims.

What is claimed is:

1. A computer implemented method comprising:
creating, by a metadata server in a distributed file system and in response to a directory creation operation triggered for the first directory, at least one second director corresponding to the first directory, wherein the first directory is managed by the metadata server, and a hierarchy level of each second directory is less than a hierarchy level of the first directory; and
performing the following operations on each second directory:
selecting, from one or more other metadata servers, another metadata server whose current load value satisfies a preset load condition as a target metadata server, when it is determined, based on a directory category of the first directory and a hierarchy relationship between the first directory and the second directory, that the second directory satisfies a migration condition; and
sending directory information of the second directory to the target metadata server, and locally deleting the directory information of the second directory, to enable the target metadata server to create the second directory based on the received directory information of the second directory, and storing the operation data into the second directory when operation data for the second directory is subsequently received.

2. The method according to claim 1, wherein determining, based on the directory category of the first directory and the hierarchy relationship between the first directory and the second directory, that the second directory satisfies the migration condition comprises:
obtaining the directory category of the first directory, and obtaining a level difference between the hierarchy level of the first directory and the hierarchy level of the second directory;
respectively determining load values of corresponding metadata servers based on load information of metadata servers in the distributed file system, when the directory category of the first directory is a hotspot directory category and the level difference is not greater than a hierarchy threshold, the metadata servers comprising the metadata server; and
determining that the second directory satisfies the migration condition, when it is determined, based on the obtained load values, that the load value of the metadata server does not satisfy a load condition.

3. The method according to claim 2, wherein the method further comprises: determining that the directory category of the first directory is the hotspot directory category by:
determining, when a service corresponding to the first directory is a hotspot service, that the directory category of the first directory is the hotspot directory category; or
determining, when an access popularity of the first directory is greater than a popularity threshold, that the category of the first directory is the hotspot directory category.

4. The method of claim 2, wherein the load information comprises at least a load degree, a request processing speed, and a quantity of to-be-processed requests of the metadata server; and
the determining load values of corresponding metadata servers based on load information of metadata servers in the distributed file system comprises:
performing the following operation on load information of each metadata server:
performing weighted summation on the load degree, the request processing speed, and the quantity of the to-be-processed requests of the metadata server, to obtain a load value corresponding to the metadata server, the load degree representing a quantity of requests currently processed by the metadata server, and the load value representing a pressure degree of the metadata server.

5. The method of claim 1, wherein the selecting comprises:
sorting load values corresponding to other metadata servers in ascending order, to obtain at least one candidate load value based on ranking sequence numbers corresponding to the load values and with reference to a preset sequence number, a ranking sequence number of the at least one candidate load value being less than the preset sequence number; and
selecting, as the target metadata server, another metadata server from at least one other corresponding metadata server based on the at least one candidate load value.

6. The method according to claim 5, wherein the method further comprises selecting another metadata server as the target metadata server by:
using, as the target metadata server, another metadata server corresponding to one candidate load value that is in the at least one candidate load value and that satisfies a screening condition; or
using, as the target metadata server, another metadata server corresponding to one candidate load value randomly selected from the at least one candidate load value.

7. The method of claim 2, wherein load information that is of the other metadata servers and that is obtained by the metadata server is transmitted by the other metadata servers to the metadata server by using a heartbeat mechanism.

8. One or more non-transitory computer readable media comprising computer readable instructions that, when executed by a processor, configure a data processing system to perform:
creating, by a metadata server in a distributed file system and in response to a directory creation operation triggered for the first directory, at least one second director corresponding to the first directory, wherein the first directory is managed by the metadata server, and a hierarchy level of each second directory is less than a hierarchy level of the first directory; and
performing the following operations on each second directory:
selecting, from one or more other metadata servers, another metadata server whose current load value satisfies a preset load condition as a target metadata server, when it is determined, based on a directory category of the first directory and a hierarchy relationship between the first directory and the second directory, that the second directory satisfies a migration condition; and
sending directory information of the second directory to the target metadata server, and locally deleting the directory information of the second directory, to enable the target metadata server to create the second directory based on the received directory information of the second directory, and storing the operation data into the second directory when operation data for the second directory is subsequently received.

9. The computer readable media according to claim 8, wherein determining, based on the directory category of the first directory and the hierarchy relationship between the first directory and the second directory, that the second directory satisfies the migration condition comprises:
obtaining the directory category of the first directory, and obtaining a level difference between the hierarchy level of the first directory and the hierarchy level of the second directory;
respectively determining load values of corresponding metadata servers based on load information of metadata servers in the distributed file system, when the directory category of the first directory is a hotspot directory category and the level difference is not greater than a hierarchy threshold, the metadata servers comprising the metadata server; and
determining that the second directory satisfies the migration condition, when it is determined, based on the obtained load values, that the load value of the metadata server does not satisfy a load condition.

10. The computer readable media according to claim 9, wherein the instructions further configure the data processing system to perform determining that the directory category of the first directory is the hotspot directory category by:
determining, when a service corresponding to the first directory is a hotspot service, that the directory category of the first directory is the hotspot directory category; or
determining, when an access popularity of the first directory is greater than a popularity threshold, that the category of the first directory is the hotspot directory category.

11. The computer readable media of claim 9, wherein the load information comprises at least a load degree, a request processing speed, and a quantity of to-be-processed requests of the metadata server; and
the determining load values of corresponding metadata servers based on load information of metadata servers in the distributed file system comprises:
performing the following operation on load information of each metadata server:
performing weighted summation on the load degree, the request processing speed, and the quantity of the to-be-processed requests of the metadata server, to obtain a load value corresponding to the metadata server, the load degree representing a quantity of requests currently processed by the metadata server, and the load value representing a pressure degree of the metadata server.

12. The computer readable media of claim 8, wherein the selecting comprises:
sorting load values corresponding to other metadata servers in ascending order, to obtain at least one candidate load value based on ranking sequence numbers corresponding to the load values and with reference to a preset sequence number, a ranking sequence number of the at least one candidate load value being less than the preset sequence number; and
selecting, as the target metadata server, another metadata server from at least one other corresponding metadata server based on the at least one candidate load value.

13. The computer readable media according to claim 12, wherein the instructions further configure the data processing system to perform selecting another metadata server as the target metadata server by:
using, as the target metadata server, another metadata server corresponding to one candidate load value that is in the at least one candidate load value and that satisfies a screening condition; or
using, as the target metadata server, another metadata server corresponding to one candidate load value randomly selected from the at least one candidate load value.

14. The computer readable media of claim 9, wherein load information that is of the other metadata servers and that is obtained by the metadata server is transmitted by the other metadata servers to the metadata server by using a heartbeat mechanism.

15. A data processing system comprising: a processor, and memory storing computer readable instructions that, when executed by the processor, configure the data processing system to perform:
creating, by a metadata server in a distributed file system and in response to a directory creation operation triggered for the first directory, at least one second director corresponding to the first directory, wherein the first directory is managed by the metadata server, and a hierarchy level of each second directory is less than a hierarchy level of the first directory; and
performing the following operations on each second directory:
selecting, from one or more other metadata servers, another metadata server whose current load value satisfies a preset load condition as a target metadata server, when it is determined, based on a directory category of the first directory and a hierarchy relationship between the first directory and the second directory, that the second directory satisfies a migration condition; and
sending directory information of the second directory to the target metadata server, and locally deleting the directory information of the second directory, to enable the target metadata server to create the second directory based on the received directory information of the second directory, and storing the operation data into the second directory when operation data for the second directory is subsequently received.

16. The system according to claim 15, wherein determining, based on the directory category of the first directory and the hierarchy relationship between the first directory and the second directory, that the second directory satisfies the migration condition comprises:
obtaining the directory category of the first directory, and obtaining a level difference between the hierarchy level of the first directory and the hierarchy level of the second directory;
respectively determining load values of corresponding metadata servers based on load information of metadata servers in the distributed file system, when the directory category of the first directory is a hotspot directory category and the level difference is not greater than a hierarchy threshold, the metadata servers comprising the metadata server; and
determining that the second directory satisfies the migration condition, when it is determined, based on the obtained load values, that the load value of the metadata server does not satisfy a load condition.

17. The system according to claim 16, wherein the instructions further configure the data processing system to perform determining that the directory category of the first directory is the hotspot directory category by:
determining, when a service corresponding to the first directory is a hotspot service, that the directory category of the first directory is the hotspot directory category; or
determining, when an access popularity of the first directory is greater than a popularity threshold, that the category of the first directory is the hotspot directory category.

18. The system of claim 16, wherein the load information comprises at least a load degree, a request processing speed, and a quantity of to-be-processed requests of the metadata server; and
the determining load values of corresponding metadata servers based on load information of metadata servers in the distributed file system comprises:
performing the following operation on load information of each metadata server:
performing weighted summation on the load degree, the request processing speed, and the quantity of the to-be-processed requests of the metadata server, to obtain a load value corresponding to the metadata server, the load degree representing a quantity of requests currently processed by the metadata server, and the load value representing a pressure degree of the metadata server.

19. The system of claim 15, wherein the selecting comprises:
sorting load values corresponding to other metadata servers in ascending order, to obtain at least one candidate load value based on ranking sequence numbers corresponding to the load values and with reference to a preset sequence number, a ranking sequence number of the at least one candidate load value being less than the preset sequence number; and
selecting, as the target metadata server, another metadata server from at least one other corresponding metadata server based on the at least one candidate load value.

20. The system according to claim 19, wherein the instructions further configure the data processing system to perform selecting another metadata server as the target metadata server by:
using, as the target metadata server, another metadata server corresponding to one candidate load value that is in the at least one candidate load value and that satisfies a screening condition; or
using, as the target metadata server, another metadata server corresponding to one candidate load value randomly selected from the at least one candidate load value.
